(19) United States
(12) Patent Application Publication
(10) Pub. No.: US 2004/0116172 A1
(43) Pub. Date: Jun. 17, 2004

(54) Blackjack push

(76) Inventor: Geoffrey William Hall, West Midlands (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/654,876

(22) Filed: Sep. 4, 2003

(30) Foreign Application Priority Data
Sep. 4, 2002 (GB) 00220501.1

(51) Int. Cl. A63F 13/00

(52) U.S. Cl. 463/13

(57) ABSTRACT

A card game based on blackjack. The card game includes a deck of playing cards and a gaming cloth in which the gaming cloth defines an area where a dealer may deal two or more cards constituting a house hand and deal additional cards to one or more player areas. Each player area defining an area in which one or more hands comprising two or more cards may be dealt. The playing areas corresponding to each hand for placing a bet on the hands beating the house hand and an area in which optional bets may be placed on the dealers hand totaling a predetermined value of from 22 to 26 points.

This invention relates to casino house games or, more specifically, the invention relates to the casino game of Blackjack.

Blackjack is a popular casino game and various steps have been taken to try and keep the game interesting and stimulating for the players. This invention allows the casino to enjoy an additional edge in the game, by allowing the dealer to ‘push’ i.e. not pay players when the dealer has reached a designated total higher than 21.

Normally, in the game of regular Blackjack, any total of 22-26 is considered a ‘bust’ hand so, by choosing 1 or more of these totals to now be a ‘push’, will create an extra edge for the casino.

To compensate for this extra edge given to the casino, other player-beneficial rules can be added within the game, to allow the casino edge to reduce overall to a similar edge found in regular Blackjack. Examples such as paying higher than normal odds for ‘Blackjacks’, allowing players to place additional bets after seeing their initial cards and allowing more favourable ‘doubling’ and ‘splitting’ opportunities are a few of the player benefits that could be included.

Additionally, players will be allowed to wager on whether the dealer will arrive at the specified ‘push’ total, or totals. A specially designed layout will include betting areas that allow players the option of placing a further bet (see diagram attached) and the player will win the bet if a wager has been placed in the specific betting area and the dealer has made the designated total.

Ideally, the dealer will just ‘push’ on one designated total between 22-26 and the name of the game can reflect which total has been included in the rules. For example, a game called ‘Blackjack Push 26’ will inform the players that the dealer will ‘push’ players' bets on a total of 26. Obviously, the specially designed layout will include betting areas that allow the player to wager on the outcome of the dealer making a total of 26.

A preferred embodiment of the invention will now be described, with use of the attached diagram.

A specially designed layout is used with additional betting areas having ‘22’ marked in them (see item ‘B’ diagram), as this particular embodiment allows the dealer to ‘push’ on a total of 22. Each ‘Blackjack’ betting area is divided in half (see item ‘A’ in diagram) to allow players to place 2 identical ‘Blackjack’ wagers. As the dealer is allowed to ‘push’ on a total of 22, then the players advantageous rule is that after receiving their first 4 cards, that make up the start of each of their 2 Blackjack hands, they can then decide in which order the second cards are placed. In other words, once the players have received their 2 Blackjack hands they then have the option to switch over their top 2 cards (i.e. the second cards from each Blackjack hand) For example, the player is dealt a six and an Ace as his first cards, which make up the initial part of each of his Blackjack hands. Then the player receives a ‘Jack’, on top of the 6 to make ‘16’, and a ‘4’, on top of the Ace' to make ‘soft 15’. As the Jack and the four are the second cards dealt out, then the player may switch these 2 cards over, or, put simply, interchange them. The player will now have one hand consisting of a six and a four and the other band consisting of an Ace and a Jack.

Once the player has decided whether to ‘switch’, or not, then both of the player's hands are played out as in regular Blackjack

Additionally, the player can place a wager in the ‘22’ betting area, before any cards are dealt out. This wager is left until it is the dealer's turn to play his hand. If the dealer makes any total other than 22, then he takes the player's ‘22’ wager. However, if the dealer makes a total of 22 then he will pay the player at predetermined odds.

The preferable number of player betting boxes, for this particular embodiment, would be 5 although this could be increased or decreased if the casino so desires.

As well as this specific embodiment, the invention could contain one or more of the following:—

(i) In the second embodiment, ‘Blackjacks’ would still be paid even if the dealer had reached the designated ‘push’ total.

(ii) In the third embodiment, higher odds could be awarded to the player placing a ‘push total’ bet if the dealer's ‘push’ total was made up of a specific holding. For example, in ‘Push 22’, the player could be paid much higher odds if the dealer were to obtain a total of 22 with the specific cards of 4,5,6 & 7, in any order. Again, even higher odds could be awarded if the 22 was obtained by the cards in order or even if the four cards stated in this example, were of the same suit

(iii) in the fourth embodiment, the ‘push’ feature can be included in games of Blackjack where the player is only required to play one hand.

(iv) In the fifth embodiment, the player would be allowed to increase the initial wager, if desired, after seeing either one, or more, of his own cards and also, as an extra option, after seeing the dealer's upcard. Any mixture of this could be advocated depending on the casino's edge requirements.

(v) Suited ‘Blackjacks’ could be paid at higher odds than the usual 3/2 payout.

(vi) ‘Blackjacks’ could be paid at even money.

This invention could also be used on the Internet, installed on video machines or stored on a disc and played on a computer.

1. A card game based on blackjack comprises a set of playing cards and a gaming cloth,
wherein the gaming cloth defines an area in which a dealer may deal two or more cards constituting a house hand, and a plurality of player areas;
each player area defining an area in which one or more hands comprised of two or more cards may be dealt to a player;
areas corresponding to each hand for placing a bet on the hands beating the house hand; and
an area in which optional bets may be placed on the dealers hand totalling a predetermined value form 22 to 26.
